(19) United States
(12) Patent Application Publication
(10) Pub. No.: US 2005/0047512 A1
(43) Pub. Date: Mar. 3, 2005

(54) System and method using self-synchronized scrambling for reducing coherent interference

(76) Inventors: Robert M. R. Neff, Palo Alto, CA (US); Robert E. Jewett, Redwood City, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/650,862

(22) Filed: Aug. 28, 2003

(51) Int. Cl. H04L 27/00

(52) U.S. Cl. 375/259

(57) ABSTRACT

Advantage is taken of self-synchronized scrambler techniques to randomize data transitions across an interface thereby reducing the likelihood of interference induced by legitimate data changes in the data system. This arrangement reduces cross-talk in electronic circuits which results from coherent interference.

### FIELD OF THE INVENTION

This invention relates to elimination of cross-talk in electronic circuits and more specifically to the reduction of coherent interference.

### DESCRIPTION OF RELATED ART

In high resolution Analog/Digital Converters (ADCs) or Digital/Analog Converters (DACs) signals with high signal-to-noise ratios can be corrupted by noise signals. One source of noise arises when digital signals change state from zero to one or from one to zero. This is particularly troublesome on a parallel interface where several, and perhaps all, bits may switch at once. This could occur, for example, when an 8-bit binary register has been set at the binary number 127 and the register goes to 128. In such a situation, the 8 bits change from 01111111 to 10000000 simultaneously. In this case, since the digital noise is related to the signal being generated, it can interfere with proper processing downstream, particularly where digital-to-analog and analog-to-digital transitions occur.

Techniques for solving this problem have been proposed in U.S. Pat. No. 5,793,318, entitled “SYSTEM FOR PREVENTING OF CROSSTALK BETWEEN A RAW DIGITAL OUTPUT SIGNAL AND AN ANALOG INPUT SIGNAL IN AN ANALOG-TO-DIGITAL CONVERTER;” and U.S. patent application Ser. No. 09/949,560, Publication No. US 2002/0126839, entitled “DATA ENCRYPTION FOR SUPPRESSION OF DATA-RELATED IN-BAND HARMONICS IN DIGITAL TO ANALOG CONVERTERS,” which are hereby incorporated by reference herein. The '318 patent uses a separate pseudo-random bit sequence that is exclusive-ORed (XORed) with all of the source digital bits before transmission. The output from the XOR operation is then transmitted across the digital interface to the receiver. At the receiver, the XORed data is again XORed using the generated random bit sequence that was also transmitted to the receiver. This has the effect of randomizing the number of transitions of the data bits on the interface, so that there is no correlation between transitions of the digital data and the event that caused the transition. Note that this requires a separate channel to transmit the random bit sequence (Key) information so that the data can be reconstructed.

While the concepts discussed above work properly, they require overhead for sending extra bits which overhead adds cost and complexity to each system.

Another kind of coding scheme is well known, in which no external sequence is required, and only the data stream itself is required to reconstruct the sent messages. The stream uses its recent history as a key for the current data. This is known as an autokey method. This kind of scheme has been known to cryptographers for 400 years, see, David Kahn, “The Codebreakers: The Story of Secret Writing,” Macmillian, New York, 1967, and has been used more recently in voiceband data modems, see, E. A. Lee, et al., “Digital Communications,” Klewer Academic Publishers, 1988, pp. 439-445, and in the 10 Gigabit Ethernet standard, see, R. C. Walker, et al., “64b/66b Coding Update,” presentation to IEEE 802.3ae 10 Gb/s Task Force March 2000 Plenary meeting, Mar. 7, 2000, Albuquerque, N. Mex. In data communications applications this is referred to as data scrambling, with a specific implementation known as a Self-Synchronized Scrambler, see, E. A. Lee, et al., “Digital Communications,” Klewer Academic Publishers, 1988, pp. 439-445 which is an example used in this application, and all of which are incorporated herein by reference.

### BRIEF SUMMARY OF THE INVENTION

Advantage is taken of self-synchronized scrambler techniques to randomize data transitions across an interface thereby reducing the likelihood of interference induced by legitimate data changes in the data system. This arrangement reduces cross-talk in electronic circuits which results from coherent interference.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a block diagram using scrambling in an analog-to-digital environment;

FIG. 2 shows a block diagram illustrating scrambling in a digital-to-analog environment;

FIG. 3A illustrates a single bit self-synchronizing circuit;

FIGS. 3B through 3D illustrate a parallel data scrambler using a master scrambler;

FIG. 4 illustrates a parallel self-synchronizing circuit; and

FIGS. 5 through 8 show block diagrams of serial and parallel scrambler circuits.

### DETAILED DESCRIPTION

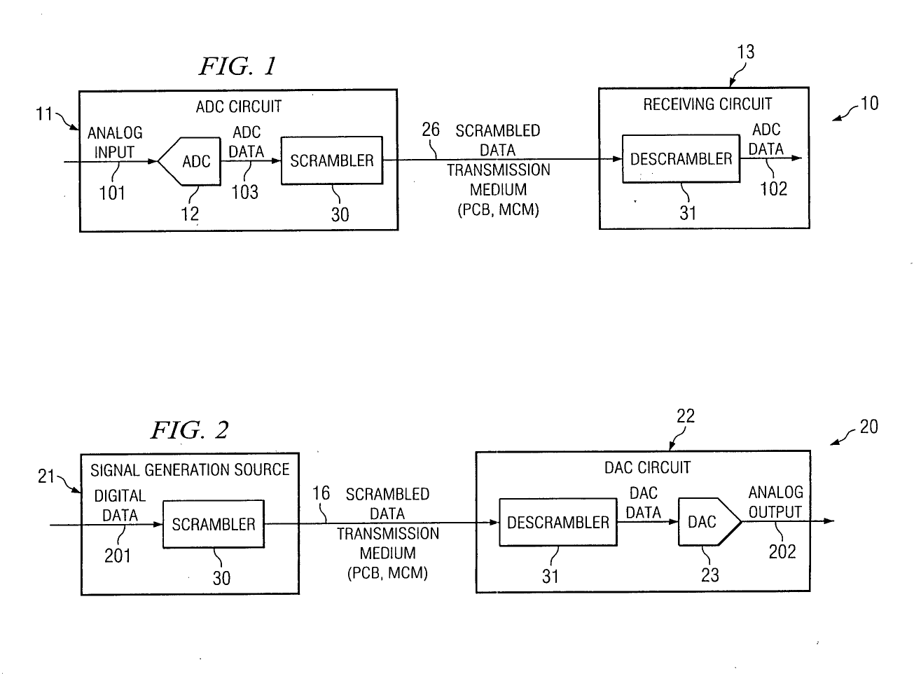

FIG. 1 shows block diagram 10 illustrating the use of a scrambling circuit with analog-to-digital converter (ADC) 12. The binary outputs from the ADC at 103 are passed to scrambler block 30, typically on the same chip. The scrambled data is transmitted in serial or parallel via transmission path 26 to receiving circuit 13. The signal-dependent patterns in the data are randomized by scrambler 30. At receive circuit 13, descrambler 31 reconstructs the ADC data for presentation to output 102. Scrambling randomizes the data so that the actual data transitions do not coincide (in time) with the change in circuit status. This makes interference with the analog input appear as “white noise”, by reducing interference caused by coherency of signal transitions with circuit changes. The transmission medium typically consists of traces on a printed circuit board (PCB), but it could be any part of the output signal path that can electrically couple back to the analog input.

FIG. 2 shows how a scrambler, such as scrambler 30, is used with digital-to-analog converter (DAC) 23. In this case, the source at input 201 contains the desired digital data that passes through scrambler 30 before transmission via line 16 to DAC circuit 22, or to any other device, such as storage, that uses digital data. Descrambler 31 descrambles the data for conversion by DAC 23 to the analog output level at output 202. Again, the scrambled data is used whenever there may be coupling from the digital data signals to the analog output.

In one embodiment, the concepts are applied to signal paths external to the circuit which contains the DAC or the ADC. However, the concepts taught herein may also be applied to data on the same integrated circuit, or in the same package, all of which may have electrical coupling to the input or output. For example, on an ADC chip with integrated memory, it may be desirable to implement the scrambling before storage to memory to randomize data dependent power consumption in the logic blocks.

An example of a use of a DAC is for processing received digital audio data for presentation to an audio speaker, or for presentation to an analog RF antenna. In such a situation, the digital data is received from a storage medium or from a transmission line (wire or wireless) and converted by the DAC for presentation to the analog equipment.

An example of a use of an ADC is for processing received analog data for storage in a memory or for transmission on a digital transmission medium. Thus, analog sound from a microphone can be converted to digital data for transmission, or analog signals received on an antenna can pass through the RF stage and then be digitized, perhaps with the help of a DSP, to remove the digital signals from noise.

A Self-Synchronized Scrambler is a specific example of an autokey sequence generator commonly used in data communications. See, for example, J. E. Savage, “Some simple Self-Synchronizing Digital Data Scramblers,” Bell System Technical Journal 64(2), p. 449 (February 1967), incorporated herein by reference.

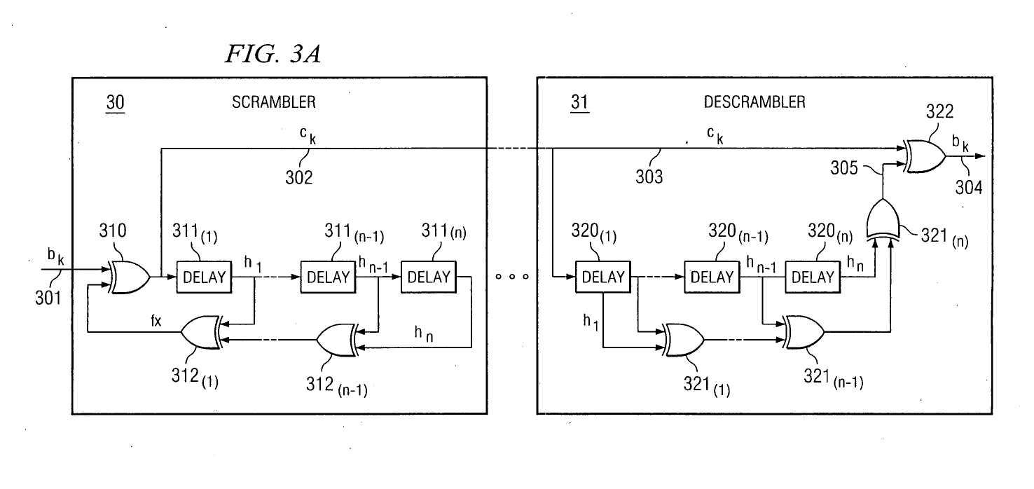

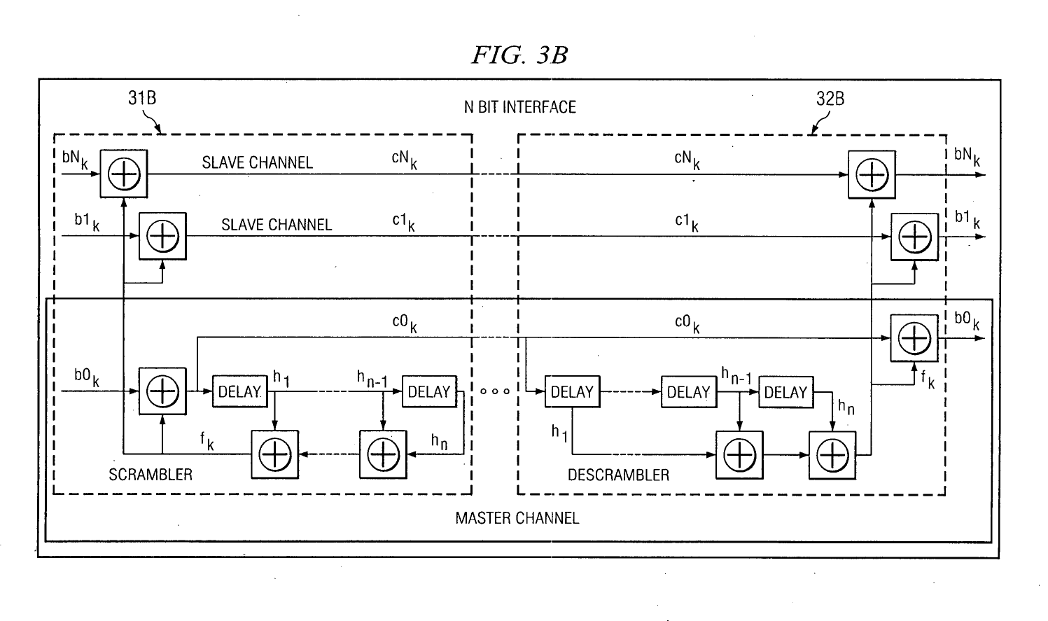

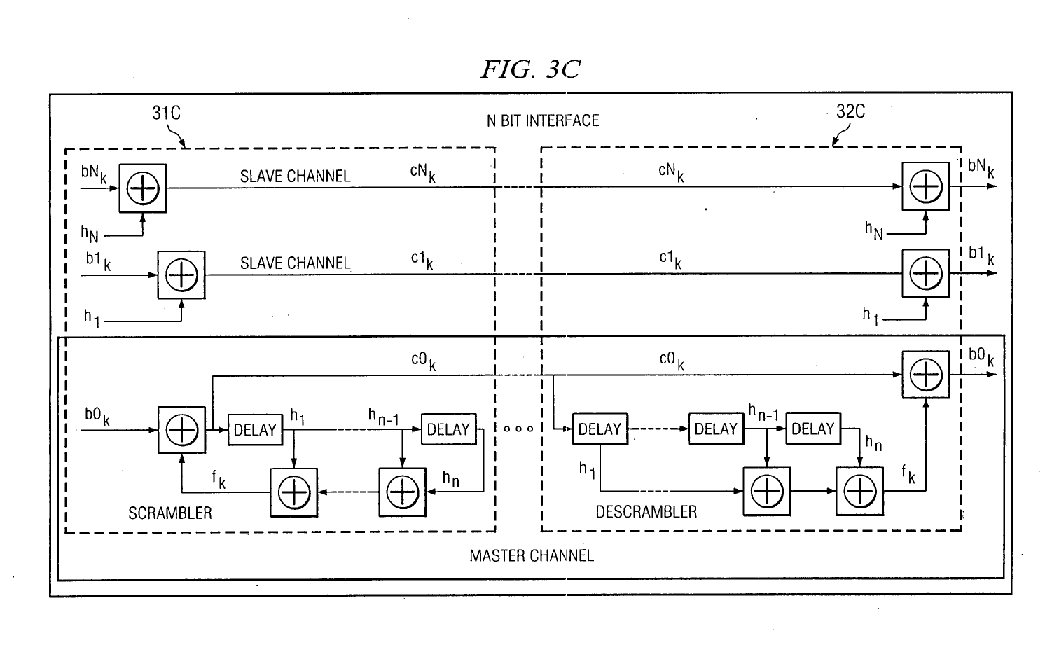

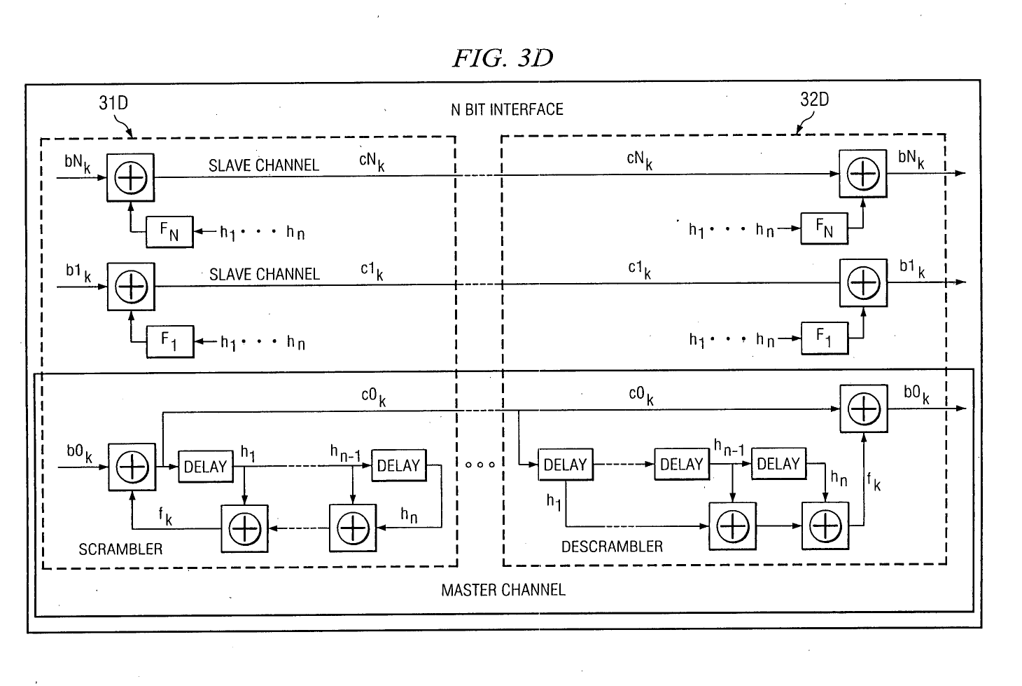

In one implementation, the scrambler used is a single bit scrambler and generates its own pseudorandom bits. These bits can be used to randomize the other parallel data bits. One example of a serial embodiment is shown in FIG. 3A, circuit 30. As shown, serial inputs, bₖ (301), carry data bits that are the input to a shift register 311₍₁₎ to 311₍ₙ₋₁₎ and 312₍₁₎ to 312₍ₙ₋₁₎, via XOR gate 310 to create a pseudo-random output cₖ(302). In this embodiment, the outputs of successive stages are XORed and the overall output fₓ is XORed with the input bₖ. Descrambler 31 replicates the same shift register and XOR gate as shown in scrambler 30, and then XORs its output 305 via XOR gate with Ck 322 to reconstruct bₖ (the original input signal) at output 304.

Note that the transmitted data, ck has its sequence randomized as it crosses the boundary between circuits 30 and 31. One potential problem is that specific input data patterns may result in long periods without data transitions, or may result in specific patterns which may cause system related problems. The length of the shift registers can be increased to reduce the probability of specific patterns, thereby increasing the randomness of the scrambler. For example, in voiceband data modems shift register lengths of 17 to 23 bits could be used. In 10G Ethernet, the shift register could be 58 bits long. Two or three taps from the shift register could be used to create the XOR product, with the choice of the intermediate taps made to optimize the length of the pseudo-random pattern. Design of these kinds of circuits is well-known. In the serial implementation shown in FIG. 1, h₁=cₖ₋₁. The scrambler function is cₖ=bₖ+cₖ₋₁+cₖ₍ₙ₋₁₎+cₖ₋ₙ.

Circuits which implement the scrambler function in a parallel manner by computing the next several bits at a time are also well known, and can be derived from the serial structure, as discussed in the above-identified Savage reference.

FIG. 3B shows a parallel data implementation where the master fₖ bit can be XORed (shown as a box with a + inside) in scrambler 318 with all the slave channel data bits to randomize them. Descrambler 32B replicates this bit, and it can also be shared. In this implementation, hardware is saved because the scrambler only needs to be created once.

One aspect of this implementation is that since the same bit fₖ is used to randomize all bits on the interface, in the case of static b0ₖ-bNₖ, the bits will have transitions at the same time, concentrating transition energy from all bit lines at the same time instance. This is a direct cause of having a single pseudo-random stream scrambling all bits.

From scrambler 31B a multitude of de-correlated pseudo-random streams can be created by recognizing that each hᵢ bit is de-correlated from every other bit in the scrambler, and additional PR streams can be generated by XORing any group of hᵢ bits. This is how the feedback bit fₖ is created.

In FIGS. 3C and 3D the un-correlated streams are used to further de-corrlate the data on the interface.

FIG. 3C shows how the hᵢ bit from the master scrambler is used to modulate the slave streams, with each slave stream using a different hᵢ bit. Another way to think of this is that the same PRBS stream is used on all channels except it is delayed at each bit, de-correlating transitions on the interface. This kind of structure is described in U.S. patent application Ser. No. 09/949,560, entitled “DATA ENCRYPTION FOR SUPPRESSION OF DATA-RELATED IN-BAND HARMONICS IN DIGITAL TO ANALOG CONVERTERS,” the disclosure of which is hereby incorporated by reference herein, but that reference uses a dedicated PRBS generator. In FIG. 3C parallel data scrambler 31C uses a master scrambler on bit 0, and XOR with hi bits from local master scrambler/descrambler randomize bits 1 to bit N on the interface. Only bits 0, 1, and N shown. N!=n. Parallel descrambler 322 descrambles the bits.

FIG. 3D shows a generalized version of the previous master/slave implementations. Here we just specify that for each bit on the interface there is a specific Fⱼ(h) used for each bit stream cⱼ on the interface. h is the vector of hᵢ bits. The function Fⱼ(h) is an XOR of a group of hᵢ bits. This is a new pseudo random bit stream which is independent of the hᵢ bit streams. The output of each Fⱼ(h) is a pseudo-random sequence. Each Fⱼ(h) has all hᵢ bits as possible inputs. The j index is for each bit on the output bus, the h₁-hₙ are for delayed states in the scrambler, and the k index indicates data samples number k.

In FIG. 3D, parallel data scrambler 31D uses a master scrambler on bit 0, and Fⱼ(h) function with hᵢ bits from local master scrambler/descrambler. Only bits 0, 1 and N are shown. N!=n. Descrambler 32D descrambles the bits.

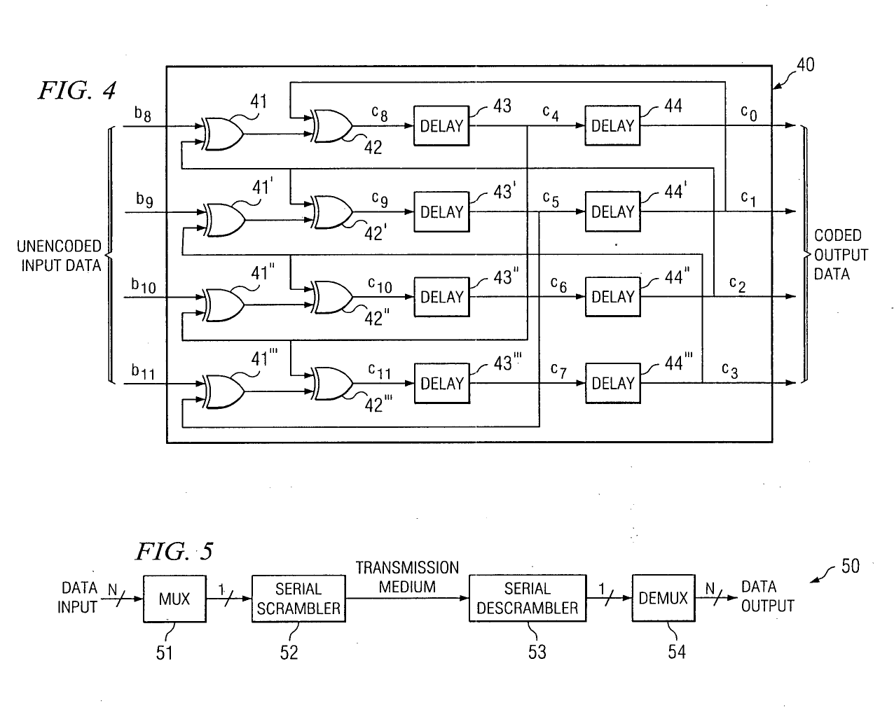

FIG. 4 shows one structure 40 which implements a scrambler function of cₖ=bₖ+cₖ₋₆+cₖ₋₇. The parallel structure is used when the bit rate is too high for a practical serial implementation, and can be extended to arbitrary width and bit rate. In one implementation, the scrambler is used for a single bit and generates its own pseudorandom bits, and those bits can be used to randomize the other parallel data bits. In order to illustrate, one example of a serial embodiment is shown in FIG. 3A, circuit 30.

While several forms of self-synchronous scrambling have been discussed herein, any other auto-key cipher which results in a randomized spectrum will also serve the purpose of reducing interference.

FIGS. 5 through 8 show implementations in which the DATA is an N bit wide parallel data stream going across the transmission medium into a DAC, or from an ADC, across a medium, to further digital processing or storage. Explicit connection to a DAC or ADC (or to other devices) is not shown in FIGS. 5 through 8, but is assumed in the system.

As shown in FIG. 5, the parallel data in circuit 50 is converted to a serial data stream through multiplexor (MUX) 51, and then serial scrambler 52 randomizes the stream. Corresponding descrambler 53 and demultiplexor (DEMUX) 54 reconstructs the data. The serial data has N-times the clock rate as the parallel data in FIG. 2. The transmission through the medium uses a single connection.

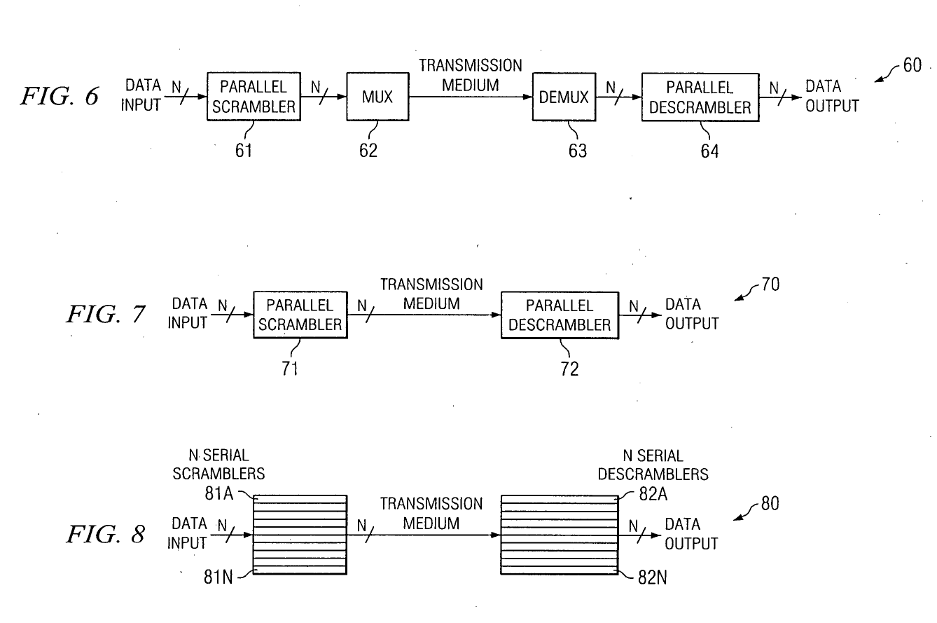

FIG. 6, circuit 60, shows that the scrambler can be implemented in parallel by adding scrambler 61 before mux serializer 62. Combinations of FIGS. 5 and 6 are possible, ie, parallel scrambler and mux across the transmission medium to a serial descrambler and demux.

FIG. 7, circuit 70, illustrates how the parallel data is directly scrambled in parallel scrambler 71, and then descrambled in parallel descrambler 72. Data in this embodiment is transmitted in N parallel paths through the medium.

FIG. 8, circuit 80, illustrates how the data is transmitted in a parallel bus, and each bit on the bus has its own serial scrambler/descrambler pair 81A-81N, 82A-82N. The N serial scramblers may be identical, or they may each have unique feedback connections giving each a unique scrambled sequence.

While the disclosure has been presented in terms of preventing cross-talk to an input of an ADC or DAC circuit, the randomization of data in one part of a system can be used to prevent cross-talk to a sensitive signal in a completely different part of the system. For example, in a radio receiver, a local oscillator (LO) is mixed with the input, and then the result is filtered and digitized by an ADC. If the ADC digital output couples back to the LO, it can affect the fidelity of the data reception through this indirect path. Using the concepts discussed above, this problem can be eliminated. Also, it should be noted that the system could be a single substrate on substrates connected together by traces on one or more printed wiring boards.

Although the present invention and its advantages have been described in detail, it should be understood that various changes, substitutions and alterations can be made herein without departing from the invention as defined by the appended claims. Moreover, the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A system for reducing coherent interference in an electronic circuit, said system comprising:
a scrambling circuit having a particular structure for accepting input data and creating scrambled data therefrom, said scrambled data having a pattern dependent upon said particular structure of said circuit; and
a descrambling circuit for accepting said scrambled data and decoding therefrom as output data, data identical to said input data, said decoding being dependent upon self-synchronization between said scrambling and said descrambling circuits, said scrambling and descrambling circuits being collocated on the same electronic circuit.

2. The system of claim 1 wherein said scrambling circuit is a single bit scrambler.

3. The system of claim 2 wherein said single bit scrambler comprises:
shift register stages, the number of said stages dependent upon data transmission rate.

4. The system of claim 3 wherein said descrambling circuit functions exactly inversely to said synchronizing circuit and has the same number of stages as said scrambling circuit.

5. The system of claim 1 wherein said scrambling circuit is a parallel bit scrambler.

6. The system of claim 1 wherein said scrambled data is presented on a parallel interface.

7. The system of claim 1 wherein said electronic circuit comprises:
an analog-to-digital converter (ADC) circuit and wherein said scrambling circuit accepts said input data from the digital output of said ADC.

8. The system of claim 1 wherein said electronic circuit is a digital-to-analog converter (DAC) circuit and wherein said output data provides the digital input to said DAC.

9. A method of transmitting digital data between two electronic components, said method comprising:
receiving digital signals from a first one of said electronic components;
scrambling of said digital signals to generate respective scrambled signals;
transmitting said scrambled signals to a second one of said electronic components; and
descrambling said scrambled signals using self-synchronization to generate respective descrambled signals prior to presenting said descrambled signals to an input of said second electronic component.

10. The method of claim 9 where said first electronic component comprises:
an analog-to-digital converter (ADC).

11. The method of claim 9 wherein said second electronic component comprises:
a digital-to-analog converter (DAC).

12. A circuit for randomizing data values with respect to the input data values, said randomized data values for communication between electronic circuits, said circuit comprising:
a scrambling circuit for accepting an output data signal from a first electronic circuit and for providing a scrambled output;
a path for communicating said scrambled output to a destination; and
a self-synchronizing descrambling circuit at said destination for receiving said scrambled output and for descrambling said scrambled output to reconstruct said output data signal, said scrambling circuit and said descrambling circuit being complimentary.

13. The circuit of claim 12 wherein said first circuit comprising:
an analog-to-digital converter (ADC).

14. The circuit of claim 13 wherein said second circuit comprises:
a digital-to-analog converter (DAC).

15. The circuit of claim 12 wherein said first circuit comprises:
a DAC.

16. The circuit of claim 15 wherein said second circuit comprises:
an ADC.

17. A system for transmitting a digital signal between two electronic components, said system comprising:
means for receiving the digital signal from a first one of said electronic components;
means for scrambling a received digital signal;
means for transmitting said scrambled signal to a second one of said electronic components; and
means, including circuitry complimentary to said scrambling means at said second circuit, for descrambling said scrambled signal using self-synchronization.

18. The system of claim 17 wherein said first electronic component comprising:
an analog-to-digital converter (ADC).

19. The system of claim 17 wherein said second electronic component comprises:
a digital-to-analog converter (DAC).

20. The system of claim 17 wherein said scrambling means comprises:
at least one serial scrambler.

21. The system of claim 17 wherein said serial scrambler comprises:
a multi-path scrambler.

22. The system of claim 17 wherein said scrambling means comprises:
a parallel scrambler.

23. A method for reducing coherent interference in electronic circuits, said method comprising:
accepting data from a data source and creating output data therefrom, said output data having a scrambled data pattern dependent upon a particular circuit structure, said data source being located at one location of an electronic circuit; and
accepting, at a location in said electronic circuit different from said one location, said scrambled output data and decoding therefrom as output data identical to said data accepted from said source, said decoding being dependent upon self-synchronization resulting from the use of complimentary logic for both creating and decoding said scrambled data pattern.
